(19) United States
(12) Patent Application Publication
(10) Pub. No.: US 2017/0184436 A1
(43) Pub. Date: Jun. 29, 2017

(54) METHOD OF OPERATING A SENSOR ASSEMBLY FOR A FLUID TANK OF A MOTOR VEHICLE, AND CORRESPONDING SENSOR ASSEMBLY

(71) Applicant: AUDI AG, lngolstadt (DE)

(72) Inventor: KONRAD AIGNER, Neustadt-Hienheim (DE)

(73) Assignee: AUDI AG, Ingolstadt (DE)

(21) Appl. No.: 15/378,889

(22) Filed: Dec. 14, 2016

(30) Foreign Application Priority Data
Dec. 23, 2015 (DE) 10 2015 016 775.8

(51) Int. Cl. G01F 23/24; G01F 23/26

(52) U.S. Cl. CPC G01F 23/24; G01F 23/26

(57) ABSTRACT

In a method of operating a sensor assembly for a fluid tank of a motor vehicle, plural sensor elements of the sensor assembly are electrically connected to a sensor controller. The sensor controller determines measuring data from the sensor elements, and transmits the measuring data from at least some of the sensor elements separately and at least in part sequentially to a reprogrammable control unit.

### CROSS-REFERENCES TO RELATED APPLICATIONS

This application claims the priority of German Patent Application, Serial No. 10 2015 016 775.8, filed Dec. 23, 2015, pursuant to 35 U.S.C. 119(a)-(d), the disclosure of which is incorporated herein by reference in its entirety as if fully set forth herein.

### BACKGROUND OF THE INVENTION

The present invention relates to a method of operating a sensor assembly for a fluid tank of a motor vehicle, and to a corresponding sensor assembly.

The following discussion of related art is provided to assist the reader in understanding the advantages of the invention, and is not to be construed as an admission that this related art is prior art to this invention.

A sensor assembly of a type involved here is operably connected to a fluid tank of a motor vehicle or can be a part of the fluid tank. The sensor assembly can be used, for example, to determine a fill level of a fluid contained in the fluid tank, in which case the sensor assembly is referred to as fill level sensor assembly. Of course, other parameters may be determined as well, such as, e.g., a fluid parameter of the fluid, such as a physical state.

It would be desirable and advantageous to provide an improved method of operating a sensor assembly for a fluid tank of a motor vehicle to obviate prior art shortcomings and to enable a flexible analysis of the sensor elements.

### SUMMARY OF THE INVENTION

According to one aspect of the present invention, a method of operating a sensor assembly for a fluid tank of a motor vehicle includes electrically connecting plural sensor elements of the sensor assembly to a sensor controller, determining by the sensor controller measuring data from the sensor elements, and transmitting the measuring data from at least some of the sensor elements separately and at least in part sequentially to a reprogrammable control unit.

The sensor elements of the sensor assembly are operably connected to the fluid tank and can be accommodated in the fluid tank or in a tank interior of the fluid tank so as to be in contact with the fluid, when the fill level of the fluid is adequate. Of course, the sensor elements may also be arranged in a tank wall that bounds the tank interior at least in part in the absence of a direct contact of the fluid with the sensor elements. In general, the sensor elements may be based on any functional principle, for example operate resistively, capacitively, and/or inductively.

To enable analysis of the sensor elements, the latter are electrically connected to the sensor controller. Advantageously, several sensor elements can be electrically connected to the same sensor controller. Of course, provision may also be made for several sensor controllers to which at least one of the sensor elements, suitably however several of the sensor elements, are connected. The plural sensor controllers are then connected to the control unit for transmission of the measuring data thereto. In the description, the term “measuring data” is used in a generic sense and can include a measuring value or measuring values.

The provision of both the sensor controller and the control unit results in a two-stage measuring principle or in at least a two-stage analysis of the measuring data. The measuring data provided by the sensor elements are initially ascertained by the sensor controller. Suitably, the measuring data of all of the sensor elements are ascertained by the sensor controller. The measuring data may hereby be temporarily stored in the sensor controller. Subsequently, the ascertained measuring data are transmitted to the control unit. Suitably, the measuring data directly provided by the sensor elements are transmitted to the control unit.

Provision may also be made for the measuring data, as generated by the sensor elements, to be adjusted or corrected by the sensor controller, before being transmitted to the control unit. Such an adjustment may include, for example, an evaluation of a characteristic curve and/or a threshold value, a temperature compensation and/or consideration of a reference value. In other words, the sensor controller receives raw data from the sensor elements and transposes them into measuring data for subsequent transmission to the control unit. Suitably, the raw data of at least some of the sensor elements, advantageously the raw data of each of the sensor elements, are transposed into measuring data. The measuring data for the plural sensor elements are then transmitted to the control unit for further processing. For example, the control unit determines on the basis of the measuring data the fill level of the fluid tank.

Transposition of raw data into the measuring data in the sensor controller can be realized on the basis of the characteristic line, i.e. for example based on a characteristic diagram. As an alternative, the use of a mathematical relation or a table is also conceivable, as is a transposition of raw data based on a threshold value. In this case, raw data are transposed, for example, only when exceeding a threshold value. Otherwise, the measuring data are set to an initial value, for example zero.

The measuring data are transmitted for at least some of the sensor elements, suitably for all of the sensor elements. Thus, for each of the sensor elements which generate measuring data for the sensor controller, these measuring data or corrected measuring data are then transmitted to the control unit. Thus, there is no combination of the measuring data from several sensor elements by the sensor controller. Transmission of the measuring data is realized sequentially at least in part, i.e. successively. Thus, when the sensor controller has acquired measuring data from several sensor elements, these measuring data are transmitted to the control unit successively or in part only in parallel.

Transmission may be realized via a single wire interface or a two-wire interface in order to connect the sensor controller with the control unit. Unlike the sensor controller, the control unit is reprogrammable, i.e. programming of the control unit can be modified at any time through appropriate measures, e.g. by changing the firmware. For this purpose, the control unit has, for example, an erasable and/or rewritable program memory for program code. The program code being stored in the control unit is used in particular for the analysis of the measuring data.

The measuring data transmitted from the sensor controller to the control unit are advantageously collected initially in the control unit until for each of the sensor elements measuring data has been transmitted. For example, when the sensor controller transmits the measuring data to the control unit such that initially the measuring data of a first one of the sensor elements are transmitted and subsequently measuring data of other sensor elements are transmitted until, the measuring data of a last one of the sensor elements has been transmitted. Afterwards, the sensor controller signals to the control unit that the measuring data for all sensor elements has been transmitted. The control unit accepts, for example, the measuring data of the sensor elements, until receiving this signal. Only then does the control unit commence with the analysis of the received measuring data. Suitably, the at least partly sequentially transmitted measuring data are temporarily stored in the control unit until the analysis commences.

Such a procedure has the advantage that the sensor controller is required to execute only very simple tasks and thus requires only very little arithmetic capability. In contrast thereto, the control unit can have a greater arithmetic capability and/or greater memory capacity than the sensor controller. In addition, the control unit, unlike the sensor controller, can be reprogrammed so that a later modification of the analysis of the measuring data can easily be realized by reprogramming the control unit.

For this purpose, a first program code stored in the control unit may, for example, be used to execute a first analysis of the measuring data, whereas a second program code, which is different from the first program code and can be stored in the control unit as an alternative to the first program code, is used to execute a second analysis, which in turn is different from the first analysis. Of course, the program codes may be simultaneously stored in the control unit, with only one of the program codes being used for analysis of measuring data at any give time. Such a procedure cannot be executed solely by the sensor controller because of the slight memory capacity.

The two program codes differ, for example, from one another only in terms of the number of sensor elements, the measuring data of which are being analyzed. For example, when one of the sensor elements is defective, its measuring data can be eliminated from the analysis. This is especially appropriate in a situation when the defective sensor element continues to deliver measuring data that are false and do not reflect the actual conditions in the fluid tank. In this case, by ignoring the measuring date of the defective sensor element, analysis of the measuring data will not be distorted.

The presence of a defect of a sensor element may, for example, be ascertained through a plausibility check of the measuring data. When the plausibility check establishes that the measuring date of one of the sensor elements is flawed, the measuring data of this sensor element are then eliminated from the analysis in the control unit. Unlike in the control unit, such a plausibility check can normally not be executed in the sensor controller in view of its slight arithmetic capability.

According to another advantageous feature of the present invention, the sensor controller can be provided with an unchangeable programming. Such unchangeable programming may involve, for example, a fixed wiring of the sensor controller which can be assembled from discrete components for example, or a configuration of the sensor controller as application-specific integrated circuit (ASIC). As an alternative, provision may, of course, be made for the sensor controller to have a microcontroller or a microprocessor for executing the program code. This program code should, however, not be changeable, i.e. stored for example in a read-only memory (ROM) or read-only storage. The content of the read-only memory, i.e. the program code, is neither erasable nor changeable. Only the sensor controller as a whole can be exchanged. This, however, should be avoided for cost reasons.

As an alternative, provision may also be made for the programming of the sensor controller to be changeable, i.e. the sensor controller has an exchangeable program code. For example, the program code may for this purpose be stored in an exchangeable memory chip, an erasable programmable read-only memory (EPROM) or an electrically erasable programmable read-only memory (EEPROM), especially a flash-EEPROM.

According to another advantageous feature of the present invention, the sensor elements can be linked to the sensor controller separately from one another, and the sensor elements can be activated by the sensor controller in parallel via their link for determining the measuring data.

According to another advantageous feature of the present invention, at least some of the sensor elements can be jointly linked to the sensor controller, and the sensor elements can be activated by the sensor controller multiplexed via their link for determining the measuring data.

While the sensor elements can be activated by the sensor controller sequentially, i.e. successively, it is normally suitable to ascertain the measuring data for at least some of the sensor elements, advantageously for all of the sensor elements, in parallel. In this manner, a great number of sensor elements can be rapidly queried and the obtained measuring data can be transmitted afterwards to the control unit. In order to transmit the measuring data, after being acquired in parallel by the sensor controller, at least in part sequentially to the control unit, the sensor controller can include a temporary storage for the measuring data. As an alternative, provision may be made for at least some of the sensor elements, suitably all of the sensor elements, to be jointly connected via the same link or same lines with the sensor controller. Activation of the sensor elements by the sensor controller can be implemented by multiplexing in this way.

According to another advantageous feature of the present invention, the measuring data of all sensor elements can be transmitted sequentially to the control unit. This has been described above. Sequential transmission has the advantage that only a small number of data lines are needed for transmission.

According to another advantageous feature of the present invention, the measuring data can be transmitted to the control unit via a single wire interface or a two-wire interface. The provision of a serial interface as interface is advantageous for transmission of the measuring data to the control unit. A single wire interface is useful because of the presence of a single data line only. Of course, there may be a need to provide a ground line. The two-wire interface has precisely two data lines, with one of the data lines being used as timing line for example.

According to another advantageous feature of the present invention, the control unit can determine on the basis of the measuring data a fill level of the fluid tank and/or a physical state value for each of subvolumes of the fluid tank and/or a cavity parameter of at least one cavity formed by a fluid in the fluid tank. As described above, the control unit can be configured to basically analyze any measuring data.

For example, the control unit is able to determine the fill level of the fluid tank or of the fluid within the fluid tank. Advantageously, the measuring data of the geodetically highest sensor element can be determined, which is entirely or at least in part in contact with the fluid. This enables inference about the fill level. As a result of the comparably high arithmetic capability and/or memory capacity of the control unit, a subvolume of the fluid tank can be assigned for example to each sensor element and the size of the subvolume, which is filled with fluid, can be stored in the control unit so long as the sensor element indicates the presence of fluid.

In such a configuration, the fill level or, more precisely, the fill volume can be determined by adding up or integrating the size of the respectively assigned subvolume for those sensor elements which provide measuring data that indicate the presence of fluid. In this way, the fill level or fill volume can be very accurately determined.

In addition, or as an alternative, the physical state of the fluid in the region of the sensor element can be derived from the measuring data. Thus, a physical state value to indicate the physical state can be determined. This applies for the subvolume which is assigned to the corresponding sensor element. The physical state value is determined for example for all sensor elements and thus for all subvolumes assigned to the sensor elements.

It is further conceivable to analyze the measuring data for the presence in the fluid tank of a cavity that is formed by the fluid. This may be experienced for example, when part of the fluid is frozen. The term “cavity parameter” involves, for example, a location or position, a size, or a shape of the cavity. It is, of course, conceivable to determine several of the cavity parameters or even all of the cavity parameters.

Based on the various analysis options, it is possible to detect when, for example, refilling of the tank is needed, i.e. filling of fluid into the fluid tank, even when the fluid in the fluid tank is frozen, at least in part. In the latter case, there is a possibility that topped up fluid can collect on the frozen fluid. As the sensor elements are analyzed individually, the presence of topped up fluid and/or the quantity thereof can be reliably detected.

According to another advantageous feature of the present invention, determination of the fill level, and/or the physical state values and/or the cavity parameters is realized by further taking into account at least one state parameter of the motor vehicle. The afore-mentioned values or parameters are oftentimes dependent, at least in part, on the at least one state parameter. By considering the state parameter, accuracy during determination of the fill level, and/or the physical state values and/or the cavity parameters is improved.

Normally, the sensor controller is not capable to take into account the state parameter, because the sensor controller does not receive the state parameter or because the arithmetic capability of the sensor controller is inadequate for a corresponding analysis. Examples of a state parameter of the motor vehicle include acceleration of the motor vehicle, in particular in longitudinal direction, in upward or downward direction and/or in transverse direction, and/or an angle of incline, in particular in longitudinal direction or in transverse direction.

According to another advantageous feature of the present invention, the control unit can operate an actuator, operably connected to the fluid tank, as a function of the fill level, and/or the physical state values and/or the cavity parameters. The actuator may, for example, be a heating unit by which frozen fluid in the fluid tank can be thawed, or a shaker for bulk material in a fluid tank configured as bulk material tank. The heating unit can be configured in such a way that regions of the fluid tank can be heated. For this purpose, the heating unit can have several heating sections which are associated to different regions of the fluid tank.

The control unit is thus able to determine on the basis of the measuring data or in dependence on the fill level, the physical state values or the cavity parameters those regions in which frozen fluid is present. The heating unit can then be operated to heat only those regions which have frozen fluid. This reduces energy consumption by the heating unit.

According to another advantageous feature of the present invention, the control unit can be configured to execute on the basis of the measuring data a functional test of the sensor assembly. This may involve, for example, the afore-described plausibility check of the measuring data. For example, a test may be performed to check whether the measuring data are within physically reasonable limits. If this is not the case, inference can be made that the corresponding sensor element is defective or that the sensor assembly as a whole is defective. When detecting a defect, appropriate measures can be initiated.

According to another aspect of the present invention, a sensor assembly for a fluid tank of a motor vehicle includes a sensor controller, a plurality of sensor elements electrically connected to the sensor controller, and a reprogrammable control unit, the sensor controller being configured to determine measuring data outputted by the sensor elements and to transmit the measuring data for at least some of the sensor elements separately and at least in part sequentially to the control unit.

### BRIEF DESCRIPTION OF THE DRAWING

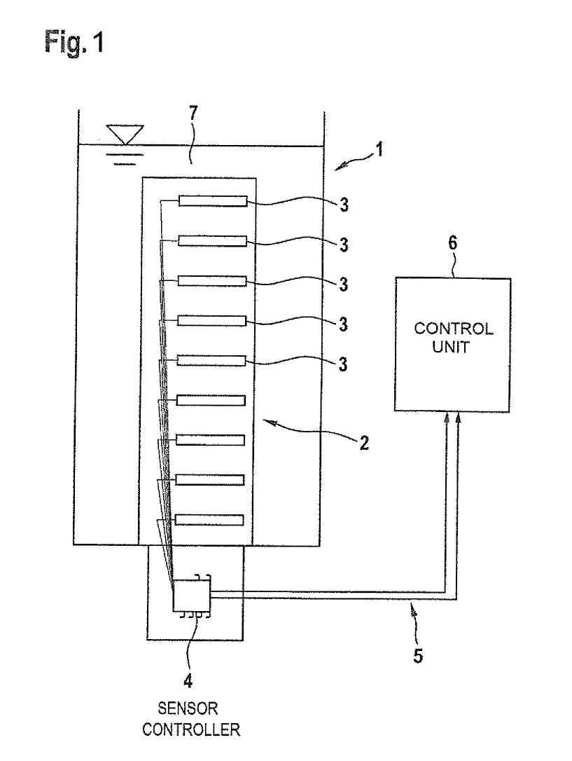

Other features and advantages of the present invention will be more readily apparent upon reading the following description of currently preferred exemplified embodiments of the invention with reference to the accompanying drawing, in which the sole FIG. 1 shows a schematic illustration of a fluid tank of a motor vehicle with a sensor assembly according to the present invention.

### DETAILED DESCRIPTION OF PREFERRED EMBODIMENTS

The depicted embodiment is to be understood as illustrative of the invention and not as limiting in any way. It should also be understood that the figure may not necessarily be to scale. In certain instances, details which are not necessary for an understanding of the present invention or which render other details difficult to perceive may have been omitted.

Turning now to FIG. 1, there is shown a schematic illustration of a fluid tank, generally designated by reference numeral 1, of a motor vehicle which is not shown in greater detail. The fluid tank 1 includes a sensor assembly 2 which in the exemplified embodiment shown in FIG. 1 includes a plurality of sensor elements 3, of which only few are depicted by way of example. The sensor elements 3 are electrically connected to a sensor controller 4 of the sensor assembly 2.

Currently preferred is a configuration in which all the sensor elements 3 are separately connected to the sensor controller 4, i.e. via distinct signal lines. The sensor controller 4 is connected via a two-wire interface 5 to a control unit 6. Instead of the two-line interface 5, the provision of any other interface is, of course, also conceivable.

The sensor elements 3 provide measuring data which are ascertained by the sensor controller 4, for example at least in part, advantageously entirely, in parallel. In the latter case, the sensor controller 4 simultaneously queries all sensor elements 3 and stores the corresponding measuring data. Provision may be made for a correction of the measuring data determined by the sensor controller 4 and subsequent storage of the corrected measuring data.

The measuring data are then transmitted from the sensor controller 4 via the two-wire interface 5 to the control unit 6. This is implemented for at least some of the sensor elements 3 separately, so that the control unit 6 receives from the sensor controller 4 separate measuring data of at least some of the sensor elements 3. Advantageously, the measuring data of all sensor elements 3 are transmitted separately from one another to the control unit 6, so that the measuring data are present initially in the sensor assembly 4 and subsequently in the control unit 6.

Transmission of the measuring data is realized at least in part sequentially, so that initially the measuring data of one of the sensor elements 3 and the measuring data of another one of the sensor elements 3 and so forth are transmitted, until the measuring data for all sensor elements 3 have been transmitted to the control unit 6.

The control unit 6 is reprogrammable, which means that a program code stored in the control unit 6 can be easily exchanged. The sensor controller 4 on the other hand has an unchangeable programming and may be composed of discrete components.

The control unit 6 assumes the task of analyzing the measuring data after having received the measuring data. For example, the control unit 6 determines on the basis of the measuring data a fill level of a fluid 7 in the fluid tank 1. In addition or as an alternative, the control unit 6 may also determine a physical state of the fluid 7 for particular subvolumes of the fluid tank 1. Also detection of a cavity or determination of a corresponding cavity parameter can easily be implemented by the control unit 6 and analysis of the measuring data by the control unit 6.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A method of operating a sensor assembly for a fluid tank of a motor vehicle, comprising:
electrically connecting plural sensor elements of the sensor assembly to a sensor controller;
determining by the sensor controller measuring data from the sensor elements; and
transmitting the measuring data from at least some of the sensor elements separately and at least in part sequentially to a reprogrammable control unit.

2. The method of claim 1, further comprising providing the sensor controller with an unchangeable programming.

3. The method of claim 1, wherein the sensor elements are linked to the sensor controller separately from one another, and further comprising activating the sensor elements by the sensor controller in parallel via their link for determining the measuring data.

4. The method of claim 1, wherein at least some of the sensor elements are jointly linked to the sensor controller, and further comprising activating the sensor elements by the sensor controller multiplexed via their link for determining the measuring data.

5. The method of claim 1, wherein the measuring data of all sensor elements are transmitted sequentially to the control unit.

6. The method of claim 1, wherein the measuring data are transmitted to the control unit via a single wire interface.

7. The method of claim 1, wherein the measuring data are transmitted to the control unit via a two-wire interface.

8. The method of claim 1, further comprising determining by the control unit on the basis of the measuring data at least one parameter selected from the group consisting of a fill level of the fluid tank, a physical state value for each of subvolumes of the fluid tank, and a cavity parameter of at least one cavity formed by a fluid in the fluid tank.

9. The method of claim 8, further comprising considering at least one state parameter of the motor vehicle, when determining the parameter.

10. The method of claim 8, further comprising operating by the control unit an actuator, which is operably connected to the fluid tank, as a function of the parameter.

11. The method of claim 1, further comprising executing by the control unit on the basis of the measuring data a functional test of the sensor assembly.

12. A sensor assembly for a fluid tank of a motor vehicle, comprising:
a sensor controller;
a plurality of sensor elements electrically connected to the sensor controller; and
a reprogrammable control unit,
said sensor controller being configured to determine measuring data outputted by the sensor elements and to transmit the measuring data for at least some of the sensor elements separately and at least in part sequentially to the control unit.

13. The sensor assembly of claim 12, wherein the sensor controller is provided with an unchangeable programming.

14. The sensor assembly of claim 12, wherein the sensor elements are linked to the sensor controller separately from one another, said sensor controller activating the sensor elements in parallel via their link for determining the measuring data.

15. The sensor assembly of claim 12, wherein at least some of the sensor elements are jointly linked to the sensor controller, said sensor controller activating the sensor elements multiplexed via their link for determining the measuring data.

16. The sensor assembly of claim 12, wherein the measuring data of all sensor elements are transmitted sequentially to the control unit.

17. The sensor assembly of claim 12, wherein the measuring data are transmitted to the control unit via a single wire interface.

18. The sensor assembly of claim 12, wherein the measuring data are transmitted to the control unit via a two-wire interface.
